(19) United States
(12) Patent Application Publication
(10) Pub. No.: US 2015/0296259 A1
(43) Pub. Date: Oct. 15, 2015

(54) ELECTRONIC APPARATUS AND CONTENT PLAYING METHOD THEREOF

(71) Applicant: Samsung Electronics Co., Ltd., Gyeonggi-do (KR)

(72) Inventors: Byoung III SON, Gyeonggi-do (KR); Young Jin KANG, Seoul (KR); Myung Geun KOH, Gyeonggi-do (KR); Hei Seong KWAK, Gyeonggi-do (KR); Woo Hee PARK, Gyeonggi-do (KR); Ung Ryeol LEE, Gyeonggi-do (KR); Min Kwon JEONG, Gyeonggi-do (KR); Min CHO, Gyeonggi-do (KR)

(73) Assignee: Samsung Electronics Co., Ltd.

(21) Appl. No.: 14/683,881

(22) Filed: Apr. 10, 2015

(30) Foreign Application Priority Data
Apr. 14, 2014 (KR) 10-2014-0043956

(51) Int. Cl. H04N 21/462; H04W 24/08; H04N 21/442; H04N 21/433; H04N 21/647; H04N 21/475; H04N 21/61; H04N 21/2665; H04N 21/6543; H04L 29/06; H04N 21/44

(52) U.S. Cl. CPC H04N 21/4622; H04L 65/4084; H04W 24/08; H04N 21/44209; H04N 21/433; H04N 21/44004; H04N 21/4755; H04N 21/6112; H04N 21/6125; H04N 21/2665; H04N 21/6543; H04N 21/64738

(57) ABSTRACT

An electronic device is provided, which include a control unit configured to play broadcasting content using a first application; and a storage unit configured to store channel information of the broadcasting content, wherein the control unit is further configured to execute a second application to play the broadcasting content according to the stored channel information when the broadcasting content is not normally played by the first application.

### PRIORITY

This application claims priority under 35 U.S.C. §119 to Korean Patent Application No. 10-2014-0043956 filed in the Korean Intellectual Property Office on Apr. 14, 2014, the entire content of which is incorporated herein by reference.

### BACKGROUND

1. Field of the Invention

The present invention generally relates to an electronic device playing content and a content playing method thereof.

2. Description of the Related Art

With the continuing development of electronic technology and communication networks, electronic devices that may play various types of content such as moving pictures, photos, and music, have been developed. Accordingly, content can be provided through a route such as a storage medium, a broadcasting network, a mobile communication network, the Internet, etc.

An electronic device typically receives content through a single route, but with the recent multi-function trend of the electronic device, it is possible to receive content through various routes from various sources.

While viewing content using an electronic device, a situation in which viewing becomes impossible due to a network state may occur. This is inconvenient in that a user will have to wait in order to view the content until the network state improves.

### SUMMARY

The present invention has been made to solve at least the above-mentioned problems and/or disadvantages and to provide at least the advantages described below.

Accordingly, an aspect of the present invention is to provide an electronic device that enables a user to conveniently view content through another application when it is difficult to view the content due to a network state while the user views the content by using an electronic device, and a content playing method of the electronic device.

According to an embodiment of the present invention, an electronic device is provided, which includes a control unit configured to play broadcasting content using a first application; and a storage unit configured to store channel information of the broadcasting content, wherein the control unit is further configured to execute a second application to play the broadcasting content according to the stored channel information when the broadcasting content is not normally played by the first application.

According to another embodiment of the present invention, a content playback method of an electronic device is provided, which includes playing broadcasting content using a first application; storing channel information of the broadcasting content being played by the first application; executing a second application when the broadcasting content is not normally played by the first application; and playing the broadcasting content according to the stored channel information using the second application.

According to another embodiment of the present invention, a non-transitory computer readable recording medium storing a program that performs a method is provided. The method includes playing broadcasting content using a first application; storing channel information of the broadcasting content being played by the first application; executing a second application when the broadcasting content is not normally played by the first application; and playing the broadcasting content according to the stored channel information using the second application.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of a configuration of an electronic device according to an embodiment of the present invention;

FIGS. 2A to 2C represent a display screen playing content during the change of an application according to an embodiment of the present invention;

FIGS. 3A to 3C represent a display screen playing content during the change of an application according to an embodiment of the present invention;

FIGS. 4A to 4C represent a display screen playing content during the change of an application according to an embodiment of the present invention;

FIGS. 5A to 5C represent a display screen playing content during the change of an application according to an embodiment of the present invention; and

FIG. 6 is a flowchart of a content playback method of an electronic device according to an embodiment of the present invention.

### DETAILED DESCRIPTION OF EMBODIMENTS OF THE PRESENT INVENTION

Various embodiments of the present invention are described below in conjunction with the accompanying drawings. Since various embodiments of the present invention may make various modifications and have many embodiments, particular embodiments will be illustrated in the drawings and related detailed descriptions are disclosed herein. However, the present invention is not intended to be limited to particular embodiments and it should be understood that the present invention covers all modifications, equivalents, and/or replacements that fall within the spirit and technical scope of the present invention. In describing the drawings, similar components are denoted through the use of similar reference numerals.

The expression “include” or “may include” that may be used in various embodiments of the present invention indicates the presence of a disclosed corresponding function, operation, or component, but does not exclude the presence or addition of one or more functions, operations, or components. Furthermore, it should be understood that the term “includes” or “has” in various embodiments of the present invention indicates the presence of characteristics, numbers, steps, operations, components, parts, or combinations thereof, but do not exclude the presence or addition of one or more other characteristics, numbers, steps, operations, components, parts, or combinations thereof.

In various embodiments of the present invention, the expression “or” or “at least one of A and/or B” includes any and all combinations of words enumerated along with the expression. For example, the expression “A or B” or “at least one of A and/or B” may include A, B, or both A and B.

The expressions “a first”, “a second”, “firstly”, or “secondly” in various embodiments of the present invention may modify various components of various embodiments of the present invention, but do not limit the corresponding components. For example, the expressions described above do not limit the order and/or importance of the corresponding components. The expressions described above may be used to distinguish one component from another. For example, both a first user device and a second user device are a user device but are different user devices. For example, without departing from the scope of the present invention, a first component may be referred to as a second component, and similarly, the second component may also be referred to as the first component.

When it is mentioned that any component is “connected” or “accessed” to another component, it should be understood that the former can be directly connected to the latter, or there may be another component in between. On the contrary, when it is mentioned that any component is “directly connected” or “directly accessed” to another component, it should be understood that there may be no other component in between.

The terms used in various embodiments of the present invention are used only to describe specific embodiments and are not intended to limit the present invention. The terms in singular form include the plural form unless otherwise specified.

Unless otherwise defined herein, all terms used herein including technical or scientific terms have the same meanings as those generally understood by a person skilled in the art to which the present invention pertain. Terms defined in generally used dictionaries should be construed to have meanings matching contextual meanings in the related art and should not be construed as having an ideal or excessively formal meaning unless otherwise defined herein.

An electronic device according to an embodiment of the present invention may be a device that includes a communication function. For example, the electronic device may include at least one of a smart phone, a tablet personal computer (PC), a mobile phone, a video phone, an e-book reader, a desktop PC, a laptop PC, a net book computer, a personal digital assistant (PDA), a portable multimedia player (PMP), an moving picture experts group audio layer 3 (MP3) player, a mobile medical device, a camera, and a wearable device (e.g., a head-mounted-device (HMD) such as electronic glasses, electronic clothing, an electronic bracelet, an electronic necklace, an electronic appcessory, an electronic tattoo, or a smart watch).

According to an embodiment of the present invention, the electronic device may be a smart home appliance having a communication function. The smart home appliance may include, for example, at least one of a TV, a digital video disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic frame.

According to an embodiment of the present invention, the electronic device may include at least one of various medical devices (e.g., a magnetic resonance angiography (MRA) device, a magnetic resonance imaging (MRI) device, a computed tomography (CT) device, a camera, and an ultrasonicator), a navigation system, a global positioning system (GPS) receiver, an event data recorder (EDR), a flight data recorder (FDR), a car infotainment device, electronic equipment for a ship (e.g., a navigation device or gyro compass for a ship), avionics, a security device, a head unit for a vehicle, an industrial or home robot, a financial institution's automated teller machine (ATM) or a store's point of sales (POS) device.

According to an embodiment of the present invention, the electronic device may include at least one of a portion of a building/structure or furniture including a communication function, an electronic board, an electronic signature receiving device, a projector, and various measurement devices (e.g., a water, electricity, gas or electric wave measurement device).

An electronic device according to an embodiment of the present invention may be one of the above-described devices or combinations of two or more of the above-described devices. An electronic device according to an embodiment of the present invention may be a flexible device. It is obvious to a person skilled in the art that electronic devices according to an embodiment of the present invention are not limited to the above-described devices.

In the following, electronic devices according to various embodiments are discussed with reference to the accompanying drawings. The term ‘user’ used in various embodiments may indicate a person who uses an electronic device, or a device (e.g., an artificial-intelligence electronic device) that uses the electronic device.

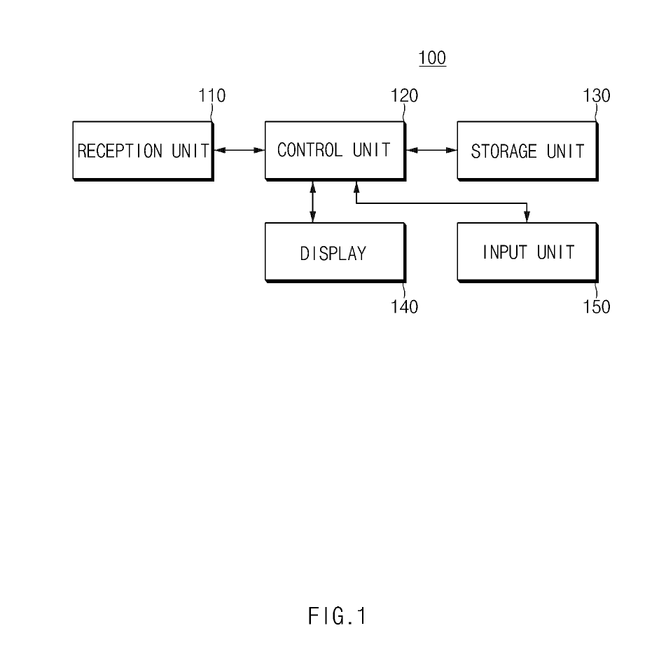

FIG. 1 is a block diagram of a configuration of an electronic device according to an embodiment of the present invention.

Referring to FIG. 1, an electronic device 100 includes a reception unit 110, a control unit 120, a storage unit 130, a display 140, or an input unit 150.

The reception unit 110 receives content. According to an embodiment of the present invention, the reception unit 110 receives broadcasting content. The broadcasting content may be content that is created and edited in a broadcasting station and transmitted through various communication networks such as a broadcasting network or an internet network.

The reception unit 110 receives the broadcasting content through various routes. For example, the reception unit 110 may receive the broadcasting content through a digital multimedia broadcasting (DMB) network, a WiFi network, and a mobile communication network. The reception unit 110 may include a plurality of communication modules. For example, the reception unit 110 may include a DMB communication module that receives the broadcasting content through a terrestrial DMB network, and a wireless communication module that accesses an internet network through a wireless communication network such as a WiFi network, a wideband code division multiple access (WCDMA) network, or an long term evolution (LTE) network, and receives the broadcasting content.

The control unit 120 executes an application that may play the broadcasting content received through the reception unit 110. The control unit 120 may use a first application to play the broadcasting content. According to an embodiment of the present invention, the first application may play the broadcasting content received through a terrestrial broadcasting network. For example, the first application may be a broadcasting-content providing application that plays the broadcasting content received through the terrestrial DMB network. As another example, the first application may be a broadcasting-content providing application that receives and plays broadcasting content from a web server.

The control unit 120 stores, channel information of the content being played by the first application, in the storage unit 130. For example, when a user views the broadcasting content received through the terrestrial DMB network, there may be channels such as UKBS Heart, UKBS Star, M YTN, QBS, SBSU, and MY MBC. When the first application is executed, a list of channels as described above may be provided by the first application and a user may select at least one channel from the list of channels to view content provided by that channel. The control unit 120 enables information on the channel selected by the user to be stored in the storage unit 130.

When it is determined that playing the broadcasting content using the first application is not normal, the control unit 120 executes a second application to play the broadcasting content according to the channel information stored in the storage unit 130. For example, the control unit 120 determines whether the playing environment of content using the first application satisfies a designated reference. When the designated reference is satisfied, the control unit 120 determines that playing the content is normally performed currently. Various examples of the designated reference are described below.

Whether the broadcasting content is normally played may be determined based on at least one of whether the broadcasting content is received, the quality of a received signal, whether a connection to a network is made, whether the broadcasting content is currently played, the buffering state of the played broadcasting content, and the quality of the played broadcasting content. For example, the control unit 120 determines that the broadcasting content is not normally played, when a signal indicated by a received signal strength indicator (RSSI) becomes weak, for example, becomes less than or equal to a preset value, when the RSSI has been changed to be greater than or equal to the preset value for a certain time, when the RSSI is irregularly changed, when a packet error rate (PER) or a bit error rate (BER) is greater than or equal to the preset value, when a connection to a network is impossible for a preset time, when the broadcasting content is not received, when the broadcasting content being played experiences the buffering for a certain time, or when the broadcasting content being played has error pixels that exceed a certain percentage of the total pixels. The electronic device 100 may determine based on at least one of the above-described examples whether the broadcasting content is normally played.

When the second application is executed, the control unit 120 uses the channel information stored in the storage unit 130 to play the content being played by the first application. For example, when the broadcasting content is not normally played while the first application plays the broadcasting content provided by the channel MY MBC, the second application is executed to be able to play the broadcasting content provided by MY MBC.

According to an embodiment of the present invention, the second application may play the broadcasting content received from a source different from that of the first application. For example, when the first application is a broadcasting-content providing application that plays the broadcasting content received through the terrestrial DMB network, the second application may play the broadcasting content received through the internet network. As another example, when the first application is a broadcasting-content providing application that receives and plays the broadcasting content from a web server, the second application may be a broadcasting-content providing application that plays the broadcasting content received through the terrestrial DMB network, or a broadcasting-content providing application that receives and plays the broadcasting content from a different web server.

When it is determined that, while the broadcasting content is played by the second application, the broadcasting content can be normally played by the first application, and the control unit 120 may use the first application for playing the broadcasting content. According to an embodiment of the present invention, when the second application plays paid broadcasting content, the control unit 120 may use the first application for playing the broadcasting content if the broadcasting content can be played for free by the first application.

The paid content may be content received through a communication network that a carrier of the communication network charges depending on data usage, or content that is charged by a content provider for a content reception (or playing) action.

The storage unit 130 stores an operation system needed for the operation of the electronic device 100, various applications or content. According to an embodiment of the present invention, the storage unit 130 may use the first application to store the channel information of the content being viewed by a user. The storage unit 130 stores the channel information of the content being currently played (e.g., the channel information lastly selected by the user). When the user changes to a second channel while viewing the broadcasting content provided by a first channel, the channel information on the second channel is stored.

According to an embodiment of the present invention, the storage unit 130 may include a last input first output (LIFO) buffer that stores the channel information. Accordingly, even if the user selects many channels, the LIFO buffer may output the channel information of the broadcasting content viewed lastly by the user.

The display 140 displays the content that the first application or the second application plays. According to an embodiment of the present invention, the display 140 may displays the broadcasting content played by the second application on a picture-in-picture (PIP) screen. The display 140 may expand the screen and display the broadcasting content played by the second application on the expanded screen based on a user input. The display 140 may reduce the expanded screen and display the broadcasting content on the reduced screen based on a user input.

The input unit 150 receives a user command. According to an embodiment of the present invention, the input unit 150 may receive a user command that selects one of channels provided by the first application. When the user command is received, the storage unit 130 stores information of a channel that has been selected by the received user command.

According to an embodiment of the present invention, the input unit 150 may receive a user command that executes the second application. The control unit 120 executes the second application based on a user input while the content is not normally played by the first application.

According to an embodiment of the present invention, the input unit 150 may receive a user command that expands the PIP screen while the broadcasting content played by the second application is displayed on the PIP screen. When the PIP screen on which the broadcasting content is played by the second application has been expanded and the broadcasting content is displayed on the expanded screen, the input unit 150 may receive a user command that reduces the expanded screen on which the broadcasting content is displayed. The display 140 may reduce or expand a screen and display the broadcasting content played by the second application according to a user command.

According to an embodiment of the present invention, the input unit 150 may receive a user command setting the second application, which is to be executed when the content is not normally played by the first application. That is, the second application may be set or selected by a user. According to an embodiment of the present invention, the user may set the second application separately according to a channel provided by the first application.

According to an embodiment of the present invention, the display 140 and the input unit 150 may be implemented in one device that enables a touch input and a display screen output, such as a touch screen.

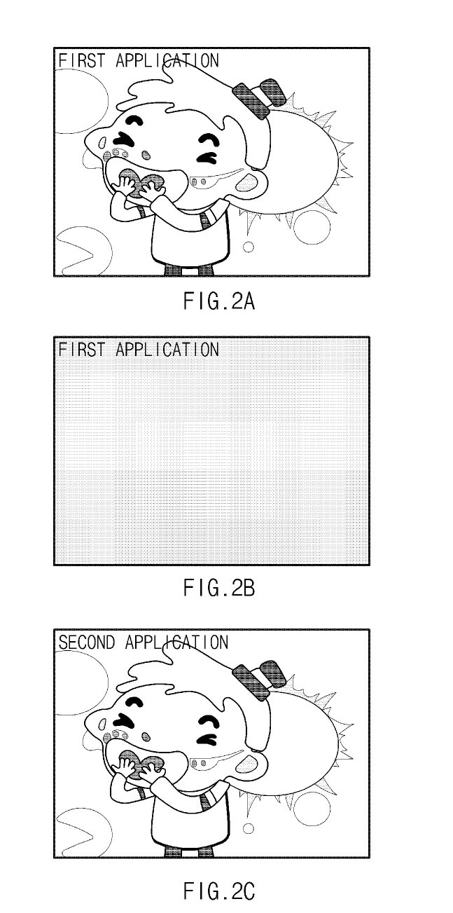

In the following, various embodiments of the present invention are described with reference to FIGS. 2A to 5C. In FIGS. 2A to 5C, the display screen of the electronic device that displays the content is described.

FIGS. 2A to 2C represent a display screen playing the content during the change of an application according to an embodiment of the present invention. In FIGS. 2A to 2C, a second application is automatically executed to play the same content when a first application does not normally play the content.

Referring to FIG. 2A, the content that the first application plays is displayed on the display screen. A user may execute the first application, select a specific channel, and view the content. Information of a channel that is selected by the user may be stored in the storage unit 130.

Referring to FIG. 2B, the content to be played by the first application is not normally played and not displayed on the display screen. When the content to be played by the first application is not normally played, the control unit automatically executes the second application. The second application may be preset by a user. The control unit 120 may use the channel information stored in the storage unit 130 to play the same content as (or corresponding to) that provided by the first application using the second application as shown in FIG. 2C.

Referring to FIGS. 2A to 2C, even if the content is not normally played while a user views the content by using the first application, the user may conveniently view the same content by using the second application.

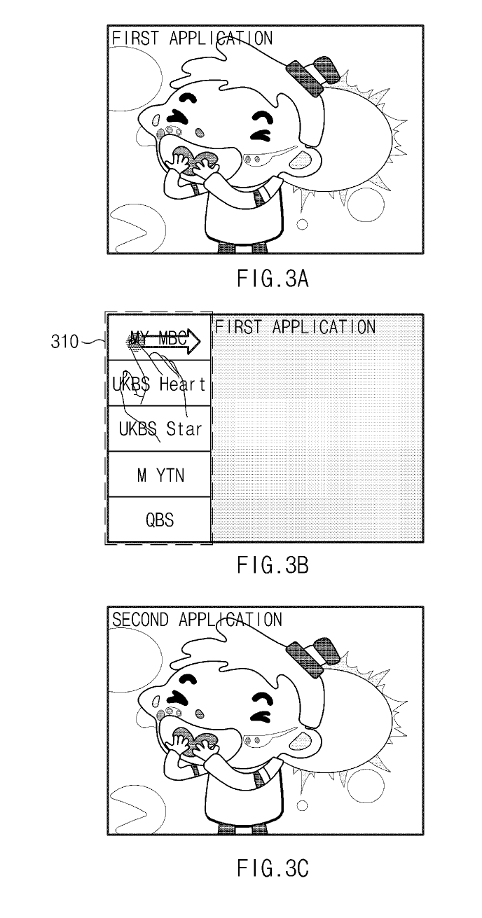

FIGS. 3A to 3C represent a display screen playing the content during the change of an application according to an embodiment of the present invention. In FIGS. 3A to 3C, when the content is not normally played by using a first application, a second application is executed according to a user command to play the same content.

Referring to FIG. 3A, the content that the first application plays is displayed on the display screen. A user executes the first application, select a specific channel, and view the content. Information on a channel that is selected by the user may be stored in the storage unit 130.

Referring to FIG. 3B, the content to be played by the first application is not normally played and thus not displayed on the display screen. In an embodiment of the present invention, when the content to be played by the first application is not normally played, a list of channels 310 is displayed. When the list of channels 310 is displayed, a user command selecting a channel is input. For example, a user inputs a “flick” command onto a channel being viewed as shown in FIG. 3B. The control unit 120 executes the second application when a user command is input.

The control unit 120 uses the channel information stored in the storage unit 130 to play the same content as that provided by the first application using the second application as shown in FIG. 3C.

Referring to FIGS. 3A to 3C, even if the content is not normally played while the user views the content by using the first application, the user may conveniently view the same content by using the second application.

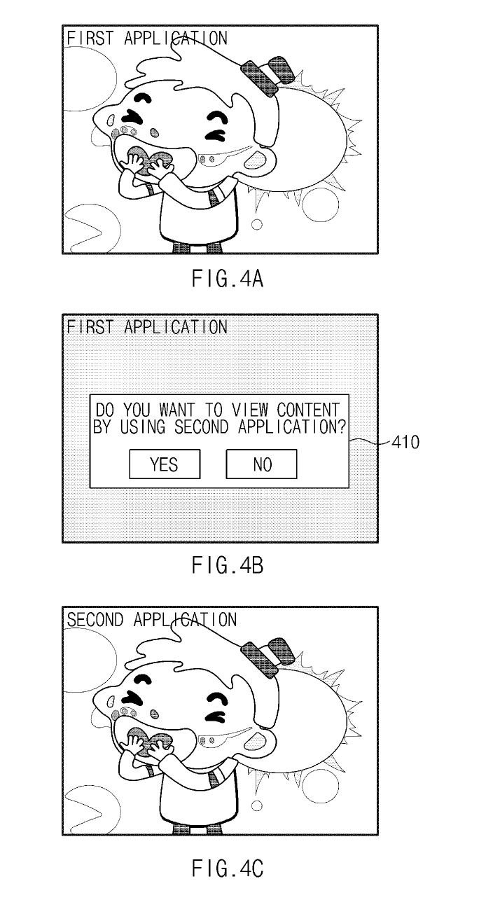

FIGS. 4A to 4C represent a display screen playing the content during the change of an application according to an embodiment of the present invention. In FIGS. 4A to 4C, when the content is not normally played by a first application, an electronic device displays a menu inquiring whether to execute the second application, and executes the second application based on a user input regarding the inquiry.

Referring to FIG. 4A, the content that the first application plays is displayed on the display screen. A user executes the first application, select a specific channel, and view the content. Information of a channel that is selected by the user may be stored in the storage unit 130.

Referring to FIG. 4B, the content is not normally played by the first application and thus not displayed on the display screen. When the content to be played by the first application is not normally played, a menu 410 inquiring whether to execute the second application is displayed. When a user command (for example, touching ‘Yes’) in response to the inquiry in the menu 410 by the user is input while the menu 410 is displayed, the control unit 120 executes the second application based on the user command.

The control unit 120 uses the channel information stored in the storage unit 130 to play the same content as that provided by the first application using the second application as shown in FIG. 4C.

Referring to FIGS. 4A to 4C, even if the content is not normally played while the user views the content by using the first application, the user may conveniently view the same content by using the second application.

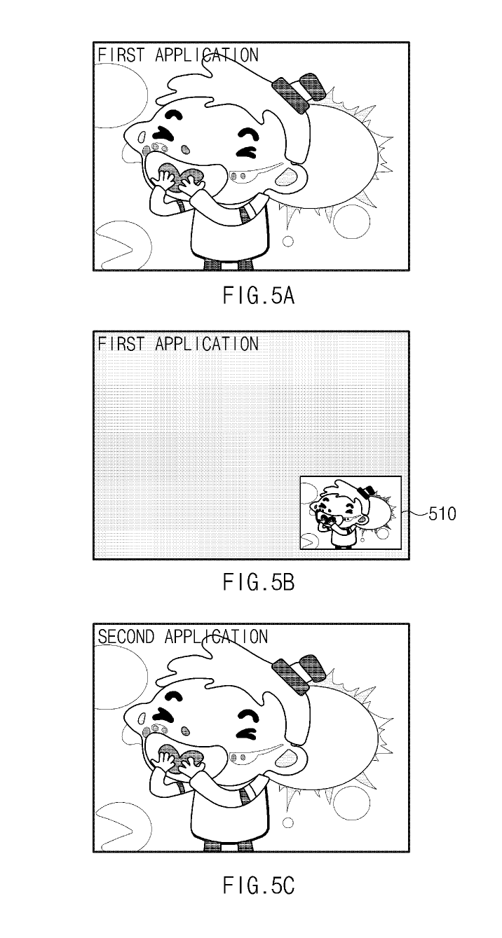

FIGS. 5A to 5C represent a display screen playing content during the change of an application according to an embodiment of the present invention. In FIGS. 5A to 5C, when the content is not normally played by using the first application, an electronic device displays a second application on a PIP screen and expands the PIP screen based on a user input.

Referring to FIG. 5A, the content that the first application plays is displayed on the display screen. A user may execute the first application, select a specific channel, and view the content. Information of a channel selected by the user may be stored in the storage unit 130.

Referring to FIG. 5B, the content to be played by the first application is not normally played. When the content to be played by the first application is not normally played, the control unit 120 executes the second application automatically or by a user command. The control unit 120 uses channel information stored in the storage unit 130 to play the same content as that provided by the first application using the second application. The second application displays the content on the PIP screen as shown in FIG. 5B.

When the content is displayed on the PIP screen and a user command expanding the PIP screen is input, the electronic device expands the PIP screen and displays the content played by the second application on the expanded screen (for example, in a full screen) as shown in FIG. 5C.

Referring to FIGS. 5A to 5C, even if the content is not normally played while the user views the content by using the first application, the user may immediately check whether it is possible to view the content by using the second application, and conveniently view the same content by using the second application through a simple input.

The electronic device 100 according to an embodiment of the present invention includes a control unit 120 that uses a first application to play broadcasting content, and a storage unit 130 that stores channel information of the broadcasting content being played by the first application, and the control unit 120 may execute a second application to play the same broadcasting content according to the stored channel information when the broadcasting content is not normally played by using the first application.

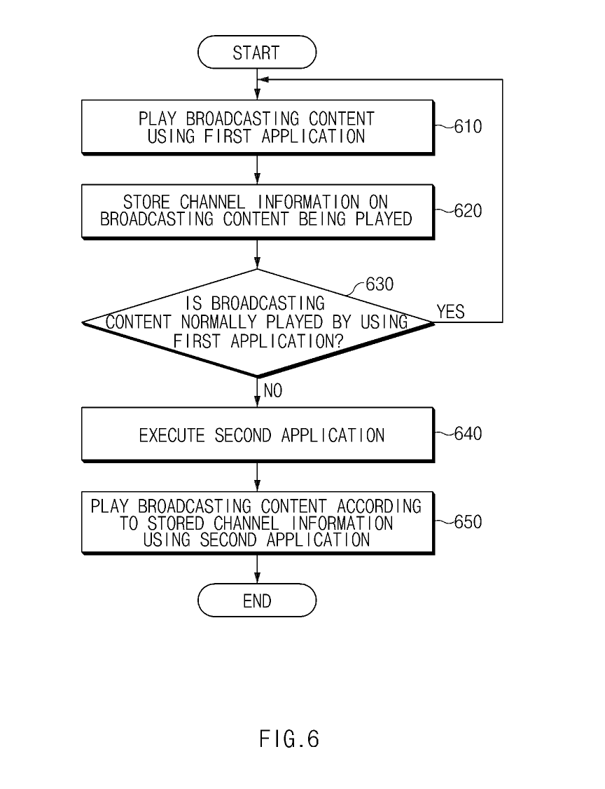

FIG. 6 is a flowchart of a content playback method of an electronic device according to an embodiment of the present invention.

The flowchart shown in FIG. 6 may include operations that are processed by the electronic device shown in FIG. 1. Thus, the descriptions of the electronic device shown in FIG. 1 or the descriptions mentioned in the embodiments of FIGS. 2A to 5C may also be applied to that of FIG. 6.

Referring to FIG. 6, in step 610, the electronic device 100 uses a first application to play the broadcasting content. According to an embodiment of the present invention, the first application may play broadcasting content received through a terrestrial broadcasting network. For example, the first application may be a broadcasting-content providing application that reproduces the broadcasting content received through the terrestrial DMB network. As another example, the first application may be a broadcasting-content providing application that receives and plays broadcasting content from a web server.

In step 620, the electronic device 100 stores the channel information of the broadcasting content being played. For example, when a user views the broadcasting content received through the terrestrial DMB network, there may be channels such as UKBS Heart, UKBS Star, M YTN, QBS, SBSU, and MY MBC. When the first application is executed, the electronic device 100 may provide a list of channels as described above, and a user may select one channel from the list of channels to view the content provided by that channel. The electronic device 100 may store information of a channel selected by the user.

According to an embodiment of the present invention, the electronic device 100 may store the channel information in a LIFO buffer. Accordingly, even if the user selects many channels, the LIFO buffer may output the channel information of the broadcasting content viewed lastly by the user.

In step 630, the electronic device 100 determines whether broadcasting content is normally played by the first application. Whether the broadcasting content is normally played may be determined based on at least one of whether the broadcasting content is received, the quality of a received signal, whether a connection to a network is made, whether the broadcasting content is currently played, the buffering state of the played broadcasting content, and the quality of the played broadcasting content. For example, the control unit 100 may determine that the broadcasting content is not normally played, when an RSSI becomes weak and becomes less than or equal to a preset value, when the RSSI has been changed to be greater than or equal to the preset value for a certain time, when the RSSI is irregularly changed, when a PER or a BER is greater than or equal to a preset value, when a connection to a network is impossible for a preset time, when the broadcasting content is not received, when the broadcasting content being played experiences buffering for a certain time, or when the broadcasting content being played has error pixels that exceed a certain percentage of the total pixels. The electronic device 100 may determine, based on at least one of the above-described examples, whether the broadcasting content is normally played.

When the broadcasting content is normally played by using the first application in step 630, the electronic device 100 uses the first application to continue to play the broadcasting content in step 610.

When the broadcasting content is not normally played by using the first application in step 630, the electronic device 100 proceeds to step 640 to execute the second application.

In step 650, the electronic device 100 uses the second application to play the broadcasting content according to the stored channel information. When the second application is executed, the electronic device 100 may use the stored channel information in step 620 to play the same content as or corresponding to that being played by the first application.

According to an embodiment of the present invention, the second application may play the broadcasting content received from a source different from that of the first application. For example, when the first application is a broadcasting-content providing application that plays the broadcasting content received through the terrestrial DMB network, the second application may play the broadcasting content received through an internet network. As another example, when the first application is a broadcasting-content providing application that receives and plays the broadcasting content from a web server, the second application may be a broadcasting-content providing application that plays the broadcasting content received through the terrestrial DMB network, or a broadcasting-content providing application that receives and plays the broadcasting content received from a different web server.

According to an embodiment of the present invention, the electronic device 100 may display the broadcasting content played by the second application on a PIP screen when using the second application to play the broadcasting content. According to an embodiment of the present invention, the electronic device 100 may expand a screen and display the broadcasting content played by the second application on the expanded screen based on a user input.

According to an embodiment of the present invention, when the normal playing of the broadcasting content using the first application becomes possible during the playing of the broadcasting using the second application, the electronic device 100 may use the first application to play the broadcasting content. For example, when the second application plays the broadcasting content, which is paid for being played using the second application, the electronic device 100 may use the first application to play the broadcasting content when the playing of the broadcasting content using the first application becomes possible.

A content playback method of an electronic device according to an embodiment of the present invention may include using a first application to play broadcasting content, storing channel information of the broadcasting content being played by the first application, executing a second application when the broadcasting content is not normally played by using the first application, and using the second application for playing the broadcasting content according to the stored channel information.

The content playback method of the electronic device according to an embodiment of the present invention as described above may be implemented in programs that may be executed on the electronic device. In addition, these programs may be stored and used in various types of recording mediums.

According to an embodiment of the present invention, when it is difficult to view content by using a specific application due to a network state, it is possible to conveniently view the content by using another application that provides the same content.

Program codes for performing the above-described methods may be stored in various types of non-volatile recording mediums such as a flash memory, a read only memory (ROM), an erasable programmable ROM (EPROM), an electronically erasable and programmable ROM (EEPROM), a hard disk, a removable disk, a memory card, a universal serial bus (USB) memory, and a compact disc ROM (CD-ROM).

Although certain embodiments have been illustrated and described above, the present invention is not limited to specific embodiments described above but may be varied by a person skilled in the art without departing from the subject matter of the present invention claimed in the following claims and the variations should not be understood separately from the spirit and scope of the present invention as defined by the appended claims and any equivalents thereof.

What is claimed is:

1. An electronic device comprising:
a control unit configured to play broadcasting content using a first application; and
a storage unit configured to store channel information of the broadcasting content,
wherein the control unit is further configured to execute a second application to play the broadcasting content according to the stored channel information when the broadcasting content is not normally played by the first application.

2. The electronic device according to claim 1, wherein the first application or the second application plays the broadcasting content received through a terrestrial broadcasting network or an internet network.

3. The electronic device according to claim 1, wherein the control unit is further configured to execute the second application when a signal indicated by a received signal strength indicator (RSSI) of the broadcasting content is less than or equal to a preset value.

4. The electronic device according to claim 1, wherein when the second application plays paid broadcasting content, the control unit is further configured to play the broadcasting content by the first application when the broadcasting content is played for free by the first application.

5. The electronic device according to claim 1, wherein the first application plays the broadcasting content received through an internet network from a first server, and the second application plays the broadcasting content received through an internet network from a second server.

6. The electronic device according to claim 1, wherein the control unit is further configured to execute the second application based on a user command.

7. The electronic device according to claim 1, further comprising a display configured to display the broadcasting content played by the second application on a picture-in-picture (PIP) screen, and to expand or reduce the PIP screen.

8. The electronic device according to claim 1, wherein the storage unit includes a last input first output (LIFO) buffer that stores the channel information.

9. The electronic device according to claim 1, wherein the control unit is further configured to determine whether the broadcasting content is normally played, based on at least one of whether the broadcasting content is received, a quality of a received signal, whether a connection to a network is made, whether the broadcasting content is currently played, a buffering state of the played broadcasting content, and a quality of the played broadcasting content.

10. A content playback method of an electronic device, the content playback method comprising:
playing broadcasting content using a first application;
storing channel information of the broadcasting content being played by the first application;
executing a second application when the broadcasting content is not normally played by the first application; and
playing the broadcasting content according to the stored channel information using the second application.

11. The content playback method according to claim 10, wherein the first application or the second application plays the broadcasting content received through a terrestrial broadcasting network or an internet network.

12. The content playback method according to claim 10, wherein executing the second application is performed when a signal indicated by a received signal strength indicator (RSSI) of the broadcasting content is less than or equal to a preset value.

13. The content playback method according to claim 10, further comprising, when the second application plays paid broadcasting content, playing the broadcasting content by the first application when the broadcasting content is played for free by the first application.

14. The content playback method according to claim 10, wherein the first application plays the broadcasting content received through an internet network from a first server, and the second application plays the broadcasting content received through an internet network from a second server.

15. The content playback method according to claim 10, wherein executing the second application is performed based on a user command.

16. The content playback method according to claim 10, further comprising:
displaying the played broadcasting content using the second application on a PIP screen; and
expanding or reducing the PIP screen.

17. The content playback method according to claim 10, wherein storing the channel information of the broadcasting content being played comprises storing the channel information in a last input first output (LIFO) buffer.

18. The content playback method according to claim 10, wherein whether the broadcasting content is normally played is determined based on at least one of whether the broadcasting content is received, a quality of a received signal, whether a connection to a network is made, whether the broadcasting content is currently played, a buffering state of the played broadcasting content, and a quality of the played broadcasting content.

19. A non-transitory computer readable recording medium storing a program that performs a method, the method comprising:
playing broadcasting content using a first application;
storing channel information of the broadcasting content being played by the first application;
executing a second application when the broadcasting content is not normally played by the first application; and
playing the broadcasting content according to the stored channel information using the second application.
